(19) United States
(12) Patent Application Publication
(10) Pub. No.: US 2016/0233002 A1
(43) Pub. Date: Aug. 11, 2016

(54) X-Ray Metal Grating Structure Manufacturing Method And X-Ray Imaging Device

(71) Applicant: KONICA MINOLTA, INC., Chiyoda-ku (JP)

(72) Inventor: Mitsuru YOKOYAMA, Takatsuki-shi (JP)

(21) Appl. No.: 15/040,737

(22) Filed: Feb. 10, 2016

(30) Foreign Application Priority Data
Feb. 10, 2015 (JP) 2015-024301

(51) Int. Cl. G21K 1/06; C25D 11/02; G01N 23/04

(52) U.S. Cl. CPC G21K 1/06; G01N 23/04; C25D 11/022

(57) ABSTRACT

An X-ray metal grating structure manufacturing method of the present invention includes: in a metal substrate having a patterned resist layer on a principal surface thereof, forming a plurality of pores in a portion of the metal substrate corresponding to a removed portion of the resist layer, by an anodic oxidation process, and removing the portion formed with the plurality of pores to form a recess. An X-ray imaging device of the present invention includes the X-ray metal grating structure manufactured by the X-ray metal grating structure manufacturing method.

### TECHNICAL FIELD

The present invention relates to an X-ray metal grating structure manufacturing method, i.e., a method for manufacturing an X-ray metal grating structure for receiving X-rays. The present invention also relates to an X-ray imaging device using an X-ray metal grating structure manufactured by the manufacturing method.

### BACKGROUND ART

A metal grating structure is utilized in various devices, as an element having a large number of parallel periodic structures, and, in recent years, its application to X-ray imaging devices has been attempted. In the field of X-ray imaging devices, from a viewpoint of reduction in exposure dose, great interest has been recently shown in X-ray phase imaging, and examples of an applicable technique therefor include a Talbot interferometer and a Talbot-Lau interferometer. In an X-ray imaging device employing the Talbot interferometer, three X-ray metal grating structures consisting of a zeroth grating, a first grating and a second grating are used. The zeroth grating is a normal grating utilizable to modify a single X-ray source to a multiple light source, i.e., to allow a flux of X-rays radiated from the single X-ray source to be divided into a plurality of fluxes of X-rays (plurality of X-ray beams) and radiate them therefrom. The first and second gratings are diffraction gratings arranged in such a manner as to be spaced apart from each other by a Talbot distance, and make up the Talbot-Lau interferometer (or Talbot interferometer). In terms of a diffraction process, the diffraction grating can be generally classified into a transmission-type diffraction grating and a reflection-type diffraction grating, wherein the transmission-type diffraction grating includes an amplitude-type diffraction grating (absorption-type diffraction grating) in which a plurality of light absorbable (absorptive) portions are periodically arranged on a light transmissible substrate, and a phase-type diffraction grating in which a plurality of optical phase changing portions are periodically arranged on a light transmissible substrate. As used here, the term “absorbable (absorptive)” means that light is absorbed by a diffraction grating at a rate of greater than 50%, and the term “transmissible” means that light is transmitted through a diffraction grating at a rate of greater than 50%.

A manufacturing method for an X-ray metal grating structure for use in such an X-ray imaging device is disclosed, for example, in JP 2012-145539A (Literature 1). A radiographic imaging grid manufacturing method disclosed in the Literature 1 comprises the steps of: forming a first insulation layer and a second insulation layer, respectively, on opposite surfaces of each of a plurality of radiation absorbable portions whose region is set in a substrate having a radiation absorbability; forming a plurality of recesses in one surface of the substrate, in a region of the one surface, except for the region of the radiation absorbable portions; and immersing the substrate in an acid solution, and applying a voltage between an electrode disposed in opposed relation to the one surface of the substrate formed with the recesses and the other surface of the substrate on a side opposite to the one surface formed with the recesses to thereby anodically oxidize the recesses to form a plurality of pores therein. A radiographic imaging grid formed by the radiographic imaging grid manufacturing method comprises a substrate having a radiation absorbability, a plurality of radiation absorbable portions whose region is set in the substrate, a plurality of radiation transmissible portions each comprised of a plurality of pores provided in a region of the substrate other than the region of the radiation absorbable portions, wherein the pores are arranged in such a manner as to be kept from overlapping each other, and peripheral walls of the pores are connected to each other.

As mentioned above, the radiographic imaging grid manufacturing method disclosed in the Literature 1 makes is possible to manufacture a radiographic imaging grid comprising a plurality of radiation transmissible portions each comprised of a plurality of pores which are arranged in such a manner as to be kept from overlapping each other and whose peripheral walls are connected to each other. Thus, each of the radiation transmissible portions in the radiographic imaging grid disclosed in the Literature 1 has the plurality of pores (through-pores) and thereby has an X-ray transmissibility (X-ray transparency) capable of transmitting X-rays to a larger extent, as compared to the X-ray absorbable portions. However, the peripheral walls of the pores are connected to each other, so that a part of the substrate still remains as the connection portion. Thus, radiation is absorbed in the connection portion, and therefore the X-ray transmissibility does not become sufficiently high or becomes uneven, in the entire radiation transmissible portion. As a result, for example, when used as a normal grating, an intensity of radiation (X-rays) transmitted through each of the radiation transmissible portions becomes lower, or, when used as a diffraction grating, clearness of a diffraction image becomes deteriorated, i.e., performance as an X-ray metal grating structure is not enough. Thus, there remains a need for improvement in the radiographic imaging grid manufacturing method disclosed in the Literature 1.

### SUMMARY OF INVENTION

The present invention has been made in view of the above circumstances, and an object thereof is to provide an X-ray metal grating structure manufacturing method capable of manufacturing a higher-performance X-ray metal grating structure, and an X-ray imaging device using an X-ray metal grating structure manufactured by the X-ray metal grating structure manufacturing method.

An X-ray metal grating structure manufacturing method of the present invention includes: in a metal substrate having a patterned resist layer on a principal surface thereof, forming a plurality of pores in a portion of the metal substrate corresponding to a removed portion of the resist layer, by an anodic oxidation process, and removing the portion formed with the plurality of pores to form a recess. This X-ray metal grating structure manufacturing method makes it possible to manufacture a higher-performance X-ray metal grating structure. An X-ray imaging device of the present invention includes the X-ray metal grating structure manufactured by the X-ray metal grating structure manufacturing method.

These and other objects, features and advantages of the present invention will become more apparent upon reading the following detailed description along with the accompanying drawings.

### BRIEF DESCRIPTION OF DRAWINGS

FIG. 1 is a perspective view depicting a configuration of an X-ray metal grating structure pertaining to a first embodiment of the present invention.

FIGS. 2A to 2D are diagrams (I) illustrating a first manufacturing method for the X-ray metal grating structure depicted in FIG. 1.

FIGS. 3A to 3D are diagrams (II) illustrating the first manufacturing method for the X-ray metal grating structure depicted in FIG. 1.

FIGS. 4A to 4D are diagrams (III) illustrating the first manufacturing method for the X-ray metal grating structure depicted in FIG. 1.

FIGS. 5A to 5D are diagrams (IV) illustrating the first manufacturing method for the X-ray metal grating structure depicted in FIG. 1.

FIG. 6 is a diagram illustrating an anodic oxidation process for forming a plurality of pores in a metal substrate.

FIG. 7 is a diagram (SEM photograph) depicting one example of an upper surface of a metal substrate in which a plurality of pores are formed by the anodic oxidation process.

FIG. 8 is a perspective view depicting a configuration of an X-ray metal grating structure pertaining to one modification of the first embodiment.

FIGS. 9A to 9D are diagrams illustrating a second manufacturing method for the X-ray metal grating structure depicted in FIG. 8.

FIG. 10 is a perspective view depicting a configuration of an X-ray metal grating structure pertaining to a second embodiment of the present invention.

FIGS. 11A to 11D are diagrams illustrating a third manufacturing method for the X-ray metal grating structure depicted in FIG. 10.

FIG. 12 is a graph illustrating a relationship between an applied voltage in the anodic oxidation process and a resulting pore pitch.

FIGS. 13A to 13D are diagrams illustrating a relationship between a width of a recess and a pore pitch.

FIGS. 14A and 14B are diagrams illustrating vignetting of X-rays radiated from an X-ray source.

FIG. 15 is a perspective view depicting a configuration of an X-ray Talbot interferometer pertaining to a third embodiment of the present invention.

FIG. 16 is a top view depicting a configuration of an X-ray Talbot-Lau interferometer pertaining to a fourth embodiment of the present invention.

FIG. 17 is an explanatory block diagram depicting a configuration of an X-ray imaging device pertaining to a fifth embodiment of the present invention.

### DESCRIPTION OF EMBODIMENTS

Based on the drawings, an embodiment of the present invention will now be described. It should be noted that elements or components assigned with the same reference sign in each figures means that they are the same elements or components, and duplicated descriptions thereof will be appropriately omitted. In this specification, for a generic term, a reference sign without any suffix is assigned thereto, and, for a term meaning an individual element or component, a reference sign with a suffix is assigned thereto.

### First Embodiment

### X-Ray Metal Grating Structure

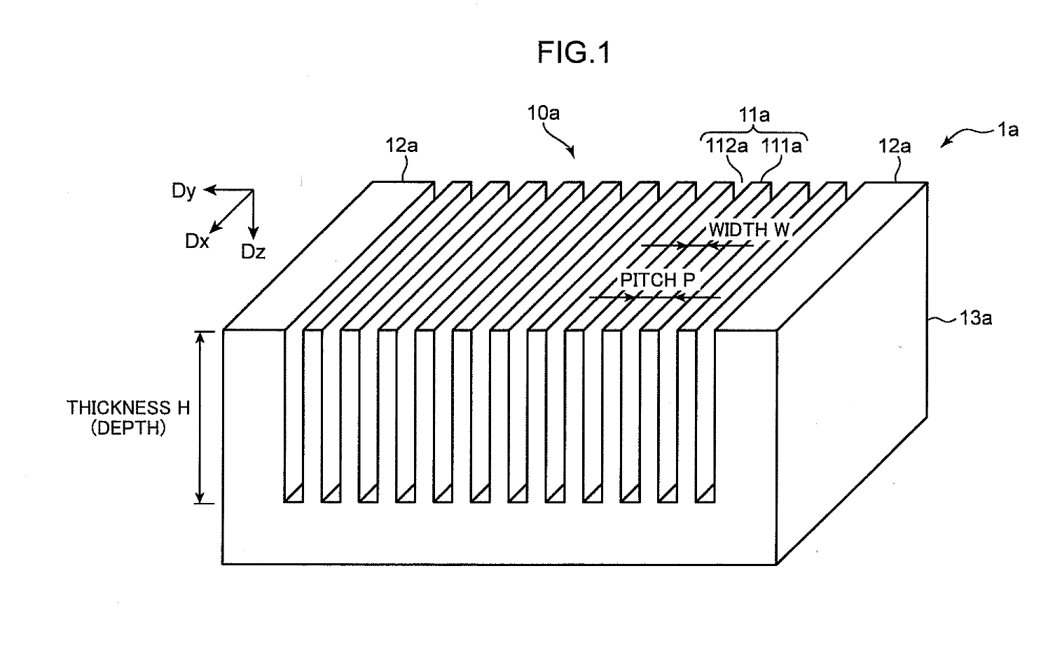

FIG. 1 is a perspective view depicting a configuration of an X-ray metal grating structure pertaining to a first embodiment of the present invention. As depicted in FIG. 1, the metal grating structure 1a pertaining to the first embodiment is constructed in such a manner that it has a grating region 10a and a rim region 12a each provided in an X-ray metal substrate 13a. The grating region 10a is a region formed with a grating 11a, and the rim region 12a is surroundingly provided around the grating region 10a.

In an orthogonal coordinate system DxDyDz defined as depicted in FIG. 1, the grating 11a includes: a plurality of X-ray absorbable portions 111a each having a given thickness (depth) H (a length in a Dz direction perpendicular to a grating plane Dx-Dy (a direction normal to the grating plane Dx-Dy)) and linearly extending in one direction Dx; and a plurality of X-ray transmissible portions 112a each having the given thickness (depth) H and linearly extending in the one direction Dx, wherein the plurality of X-ray absorbable portions 111a and the plurality of X-ray transmissible portions 112a are alternately arranged in parallel relation. Thus, the plurality of X-ray absorbable portions 111a are disposed at intervals of a given distance in one direction Dy orthogonal to the one direction Dx. In other words, the plurality of X-ray transmissible portions 112a are disposed at intervals of a given distance in the direction Dy orthogonal to the one direction Dx. In this embodiment, the given interval (pitch) P is set to a constant value. That is, the plurality of X-ray absorbable portions 111a are disposed at even intervals of the pitch P in the direction Dy orthogonal to the one direction Dx. In this embodiment, each of the X-ray absorbable portions 111a is a plate-shaped or layer-shaped solid member extending along a plane Dx-Dz orthogonal to the plane Dx-Dy, and each of the X-ray transmissible portions 112a is a plate-shaped or layer-shaped space extending along the plane Dx-Dz and interposed between adjacent ones of the X-ray absorbable portions 111a.

Each of the X-ray absorbable portions 111a functions to absorb X-rays to a relatively large extent, as compared to the X-ray transmissible portions 112a, and each of the X-ray transmissible portions 112a functions to transmit X-rays to a relatively large extent, as compared to the X-ray absorbable portions 111a. Therefore, in one aspect, the X-ray metal grating structure 1a can be utilized as a normal grating in which a pitch P thereof is sufficiently long with respect to a wavelength of X-rays so as to avoid the occurrence of Moire fringes, e.g., a zeroth grating in an X-ray Talbot-Lau interferometer. In another aspect, by appropriately setting the above given pitch P depending on a wavelength of X-rays, the X-ray metal grating structure 1a functions as a diffraction grating, and can be utilized, for example, as a first grating and a second grating in an X-ray Talbot-Lau interferometer or an X-ray Talbot interferometer. The X-ray absorbable portion 111a is formed to have an appropriate thickness H, for example, with a view to providing a sufficient X-ray absorbability conforming to specifications of an applicable device. Generally, X-rays have high penetration ability, so that a ratio of the thickness H to a width W of the X-ray absorbable portion 111a (aspect ratio=thickness/width) is set to a high aspect ratio of 5 or more. The width W of the X-ray absorbable portion 111a is equal to a length of the X-ray transmissible portion 112a in the direction Dy (a width direction thereof) orthogonal to the one direction Dx (a longitudinal direction thereof), and the thickness H of the X-ray absorbable portion 111a is equal to a length of the X-ray transmissible portion 112a in the direction Dz (a depth direction thereof) normal to the plane Dx-Dy defined by the one direction Dx and the direction Dy orthogonal to the one direction Dx.

The X-ray metal grating structure 1a is manufactured by a method comprising: a resist layer forming step of forming a resist layer (protective layer) on at least one of opposite principal surfaces of a metal substrate; a patterning step of patterning the resist layer (protective layer) and removing the patterned portion of the resist layer (protective layer); an anodic oxidation step of forming a plurality of pores in a portion of the metal substrate corresponding to the removed portion of the resist layer (protective layer), by anodic oxidation process; and a recess forming step of removing the portion formed with the plurality of pores to form a recess. For example, the recess may be formed as a slit groove in a one-dimensional grating structure, or may be formed as a columnar-shaped hole (columnar-shaped bore) in a two-dimensional grating structure. The following description will be made about details of the manufacturing method for the X-ray metal grating structure 1a in the case where the recess is formed as a slit groove. It should be noted that the details may also be applied to the case where the recess is formed in another configuration such as a columnar-shaped hole.

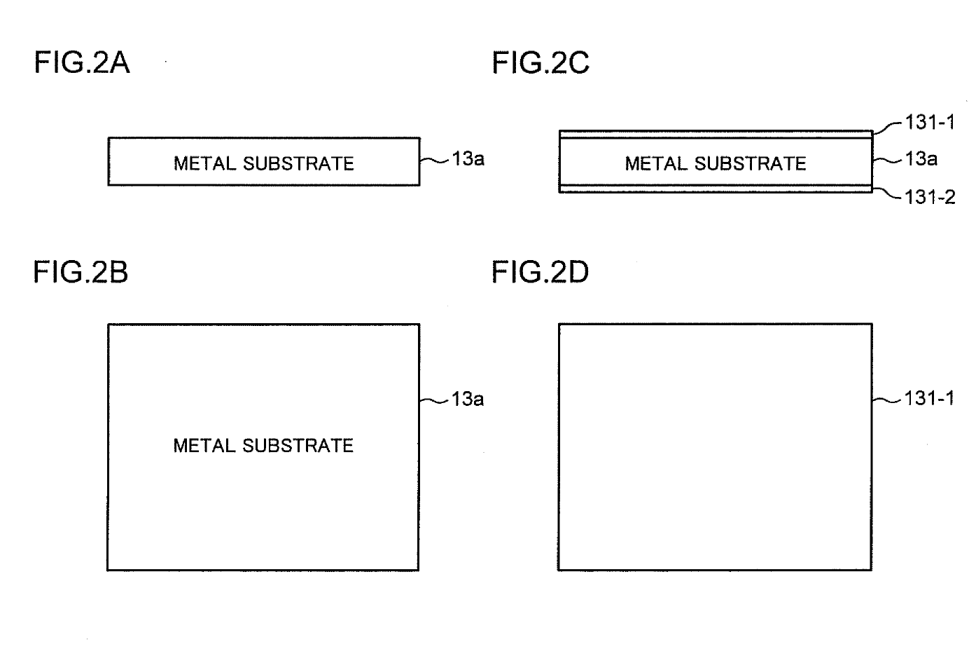

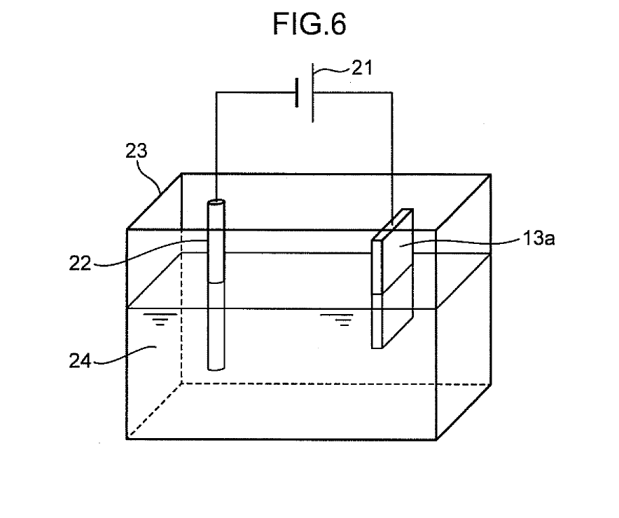

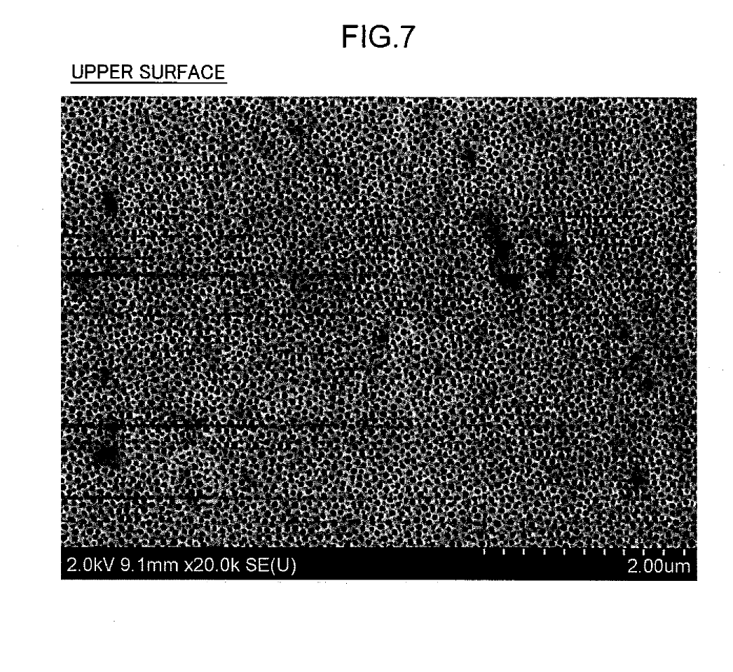

FIGS. 2A to 5D are diagrams illustrating a first manufacturing method for the metal grating structure pertaining to the first embodiment. In FIG. 2A to 5D, FIG. XA and FIG. XB are used in combination to schematically illustrate one of a plurality of manufacturing steps, wherein FIG. XA is a sectional view of FIG. XB, and FIG. XB is a top view. Further, in FIG. 2A to 5D, FIG. XC and FIG. XD are used in combination to schematically illustrate a subsequent one of the manufacturing steps, wherein FIG. XC is a sectional view of FIG. XD, and FIG. XD is a top view. FIG. 6 is a diagram illustrating an anodic oxidation process for forming a plurality of pores in a metal substrate. FIG. 7 is a diagram (SEM photograph) depicting an upper surface of a metal substrate in which a plurality of pores are formed by the anodic oxidation process, as an example.

For manufacturing the X-ray metal grating structure 1a pertaining to the first embodiment, first of all, a plate-shaped metal substrate 13a is preliminarily provided (FIGS. 2A and 2B). The metal substrate 13a is formed of a metal (including an alloy) capable of allowing a plurality of pores to be formed therein by an anodic oxidation process in the anodic oxidation step. In this manufacturing method, the metal substrate 13a is formed of a metal (including an alloy) having a high X-ray absorbability, i.e., a high ability of absorbing X-rays, because a portion remaining after the anodic oxidation step and the recess forming step is formed as the X-ray absorbable portions 111a of the grating 11a, as described later. From viewpoints of the anodic oxidation process and the high X-ray absorbability (X-ray absorbing property), the metal substrate 13a is formed of a metal such as tungsten (W) or molybdenum (Mo). In this example, the metal substrate 13a is formed of molybdenum.

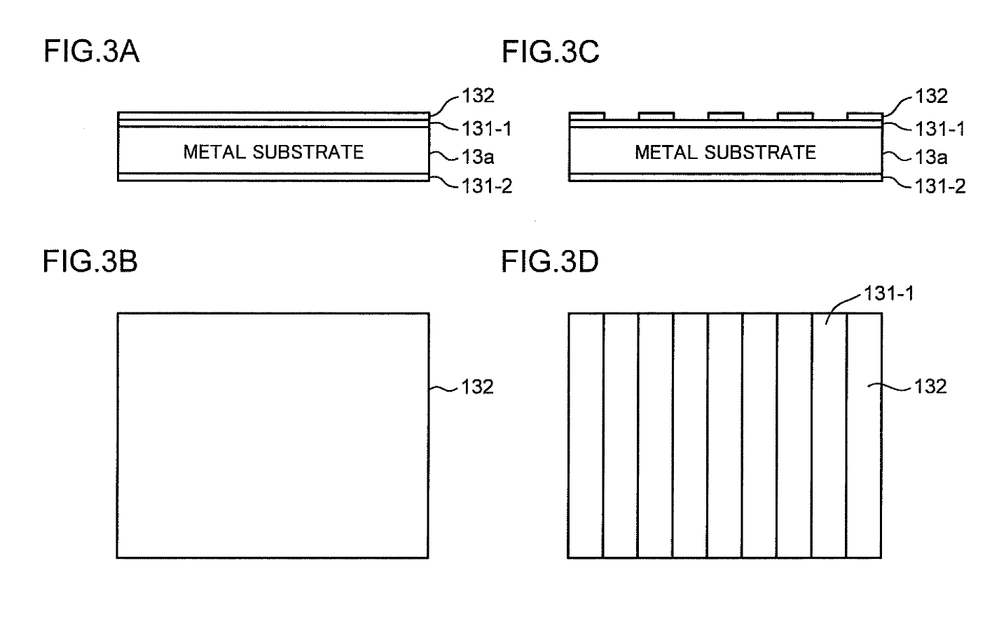

Then, a resist layer 131 (protective layer) is formed on at least one of the opposite principal surfaces of the metal substrate 13a (resist layer forming step (protective layer forming step); FIGS. 2C and 2D). The resist layer 131 is patterned, and the patterned portions of the resist layer 131 are removed (patterning step; FIGS. 3A to 3D).

More specifically, for example, in the resist layer forming step, two silica (silicon dioxide (SiO₂)) films 131-1, 131-2 are formed, respectively, on the opposite principal surfaces of the metal substrate 13a to serve as the resist layers 131. The silica films 131-1, 131-2 are formed by various film formation process such as a chemical vapor deposition (CVD) process or a sputtering process, as heretofore-known commonplace means. For example, in this embodiment, the silica films 131-1, 131-2 are formed by a plasma CVD using tetraethoxysilane. More specifically, first of all, tetraethoxysilane (TEOS) which is one kind of organic silane is heated, and bubbled using carrier gas to produce TEOS gas, and oxidation gas such as oxygen or ozone and dilution gas such as helium are mixed with the TEOS gas to produce raw material gas. Then, the raw material gas is introduced, for example, into a plasma CVD apparatus, wherein silica films 131-1, 131-2 having a given thickness (e.g., 2 μm) is formed on the surfaces of the metal substrate 13a in the plasma CVD apparatus.

In the above resist layer forming step, the resist layer 131 is formed as the silica films 131-1, 131-2. However, the resist layer is not limited thereto. The resist layer 131 is a protective layer functioning as a protective film of the metal substrate 13a against an acid liquid necessary for performing the anodic oxidation process in the anodic oxidation step, so that it is only necessary for the resist layer 131 to fulfill such a function. Thus, the resist layer 131 may be formed of a dielectric material such as silicon nitride (SiN), or a metal film.

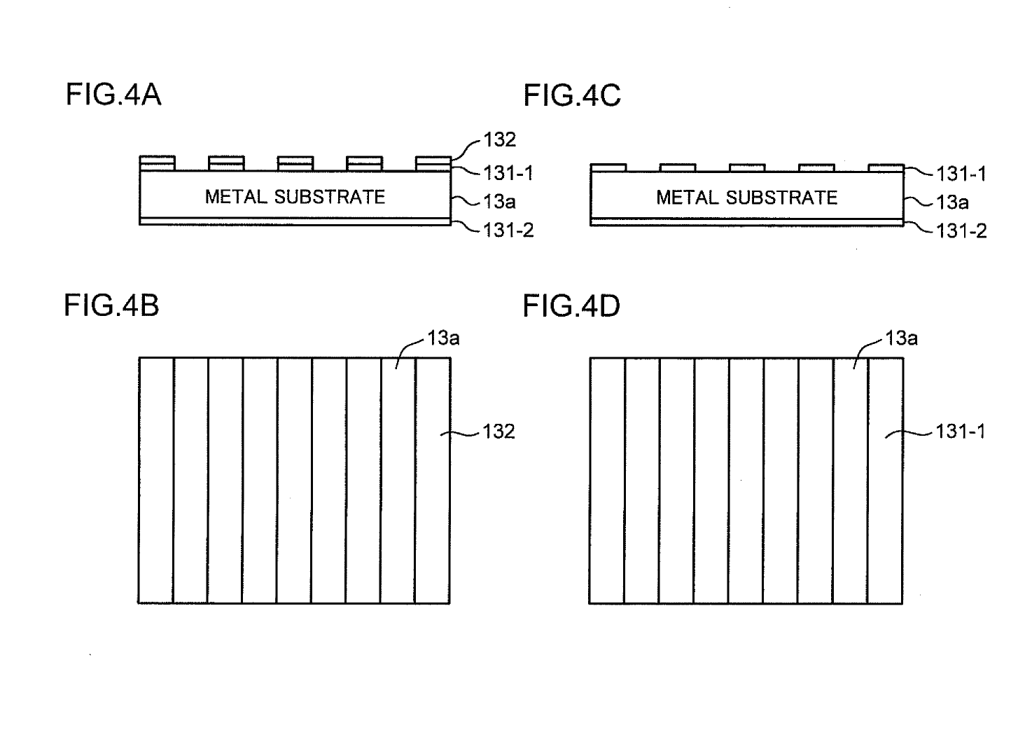

Subsequently, in the patterning step, for example, first of all, a photosensitive resin layer (photoresist layer) 132 is formed on one 131-1 of the silica films on the metal substrate 13a, by spin coating (photoresist forming sub-step; FIGS. 3A and 3B). Subsequently, as a photolithography sub-step, the photosensitive resin layer 132 is patterned by a lithographic process, and the patterned portions of the photosensitive resin layer 132 is removed (FIGS. 3C and 3D). More specifically, a non-depicted lithography mask is pressed against the photosensitive resin layer 132, and, in this state, the photosensitive resin layer 132 is irradiated with ultraviolet rays through the lithography mask in such a manner as to be patterningly exposed and developed. Then, non-exposed portions (or exposed portions) of the photosensitive resin layer 132 are removed. As a result, for example, a line and space pattern is formed in which the photosensitive resin layer 132 remains in a stripe pattern, wherein the line and space pattern has a pitch (period length) of 5.3 μm and a duty ratio of 50′. Subsequently, by using the patterned photosensitive resin layer 132 as a mask, respective portions of the silica film 131-1 corresponding to the removed portions of the photosensitive resin layer 132 are removed by etching to thereby pattern the silica film 131-1 (FIGS. 4A and 4B). More specifically, the silica film 131-1 is patterned, for example, by dry etching based on reactive ion etching (RIE) using CHF₃ gas. Alternatively, the silica film 131-1 may be patterned, for example, by wet etching using hydrofluoric acid. Then, after completion of the patterning of the silica film 131-1, the patterned photosensitive resin layer 132 used as a mask is removed (FIGS. 4C and 4D).

In the above patterning step, after forming the resist layer 131 (in the above example, the silica film 131-1), the photosensitive resin layer 132 is formed and patterned, and the resist layer 131 (in the above example, the silica film 131-1) is patterned by etching. However, a patterning process for the resist layer 131 is not limited thereto, but may be so-called “liftoff process”. In the liftoff process, for example, after forming a photosensitive resin layer on the metal substrate 13a in advance and patterning the photosensitive resin layer, a resist layer 131 (e.g., silica film) is formed, and the patterned photosensitive resin layer is removed. The liftoff process has an advantage of being able to eliminate a need for etching the resist layer 131 (e.g., silica film).

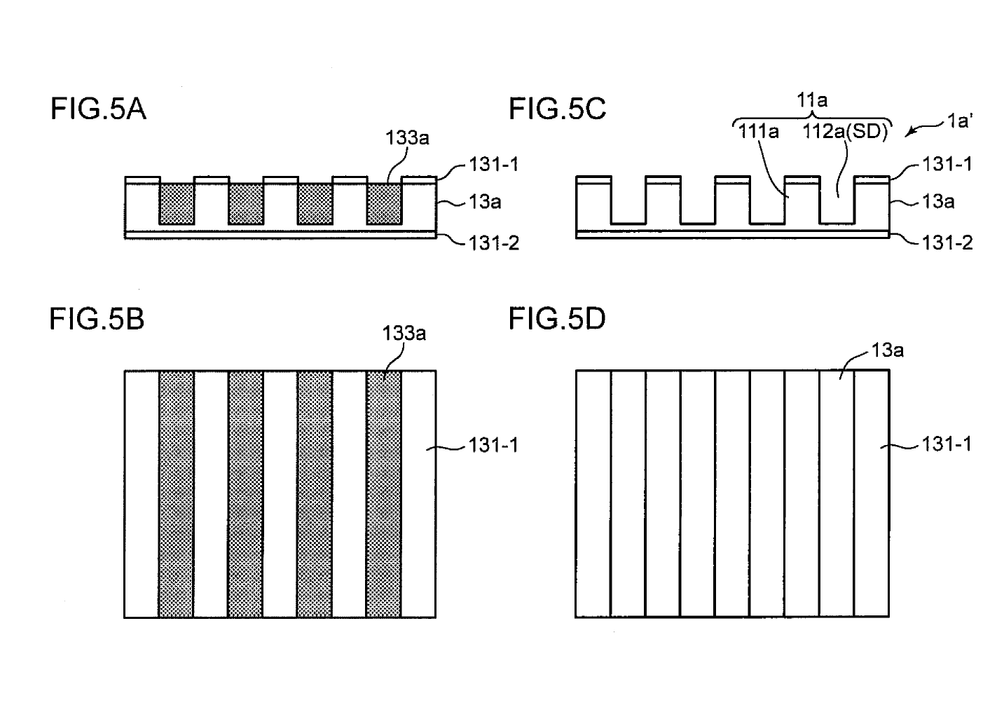

Subsequently, a plurality of pores are formed in each portion of the metal substrate 13a corresponding to the removed portions of the resist layer 131 (in the above example, the silica film 131-1) by an anodic oxidation process (anodic oxidation step; FIGS. 5A and 5B).

More specifically, in the anodic oxidation step, for example, as depicted in FIG. 6, a positive electrode of a power source 21 is energizably connected to the metal substrate 13a processed through the aforementioned steps, depicted in FIGS. 4C and 4D, and the metal substrate 13a and a cathode electrode 22 connected to a negative electrode of the power source 21 are immersed in an electrolyte solution 24 stored in a tank 23. Preferably, the electrolyte solution 24 is an acid solution having strong oxidation power and capability to dissolve a metal oxide film formed through the anodic oxidation process, such as a solution of nitric acid or oxalic acid. Preferably, the cathode electrode 22 is formed of a metal insoluble respect to the electrolyte solution 24, such as gold (Au) or platinum (Pt). In one example, with respect to the metal substrate 13a formed of molybdenum, the electrolyte solution 24 is a 0.5 M (mol concentration, mol/L) nitric acid solution, and the cathode electrode 22 is a platinum-plated titanium plate. Then, upon energization, a plurality of pores are formed in a direction from a surface toward an inside of the metal substrate 13a. In this embodiment, upon energization, a plurality of pores are formed in a direction from the surface of the metal substrate 13a in a thickness direction of the metal substrate 13a (direction Dz) with a certain distance between adjacent ones thereof. In one example, by applying a DC voltage of about 40V between the cathode electrode 22 and the metal substrate 13a, for about 7 hours, a plurality of pores each having a diameter φ of about 50 nm and a depth H of about 60 μm are formed with an average distance of about 65 nm between adjacent ones thereof. FIG. 7 depicts one example of an upper surface of the metal substrate. In FIG. 7, a photograph obtained by a scanning electron microscope (SEM) is presented as a figure.

Subsequently, the portions 133a (see FIGS. 5A and 5B) each formed with the plurality of pores are removed to form a plurality of recesses 112 (recess forming step; FIGS. 5C and 5D). That is, the portions 133a each formed with the plurality of pores is an oxide of the metal forming the metal substrate 13a, whereas the remaining portion of the metal substrate 13a, except for the portions 133a is still the metal forming the metal substrate 13a. By utilizing this difference, the portions 133a each formed with the plurality of pores are removed. For example, the portions 133a each formed with the plurality of pores can be removed by using a solution incapable of dissolving the metal of the metal substrate 13a and capable of dissolving the oxide of the metal.

More specifically, in this embodiment, for example, the metal substrate 13a processed through the aforementioned steps, depicted in FIGS. 5A and 5B, is immersed in an etching solution comprising hydrochloric acid and hydrobromic acid and having a property incapable of dissolving molybdenum and capable of dissolving molybdenum oxide, so that the portions 133a each formed with the plurality of pores are removed to form a plurality of slit groove-shaped recesses SD. The slit groove-shaped recesses SD formed in the above manner serve as the X-ray transmissible portions 112a depicted in FIG. 1, and the remaining portion remaining through the recess forming step serves as the X-ray absorbable portions 111a depicted in FIG. 1.

It is preferable to perform a resist layer removal step for removing the resist layer 131 (in the above example, the silica films 131-1, 131-2), after the completion of the recess forming step.

However, considering that a thickness of the resist layer is relatively small, and thereby an influence on performance of the resulting X-ray metal grating structure 1a is negligible, the resist layer removal step may be omitted.

Through the above manufacturing steps, the X-ray metal grating structure 1a having the configuration depicted in FIG. 1 is manufactured.

The manufacturing method for the X-ray metal grating structure 1a pertaining to the first embodiment includes the recess forming step of removing the portions 133a each formed with the plurality of pores, to thereby form a plurality of recesses (in this example, the X-ray transmissible portions 112a), and therefore the connection portion as in the aforementioned Literature 1 is eliminated. This makes it possible to manufacture a higher-performance X-ray metal grating structure 1a.

In the manufacturing method for the X-ray metal grating structure 1a pertaining to the first embodiment, the portions 133a each formed with the plurality of pores are removed by a wet etching process, in the recess forming step. Generally, in a dry etching process, due to difficulty in upsizing of an etching apparatus, a size of the metal substrate 13a to be etched is restricted by the etching apparatus. On the other hand, the manufacturing method for the X-ray metal grating structure 1a pertaining to the first embodiment employs a wet etching process in the recess forming step, and therefore it is relatively easy to upsize an etching apparatus, for example, by means of upsizing of a tank, so that the size of the metal substrate 13a to be etched can be set to a relatively large value so as to manufacture an X-ray metal grating structure 1a having a relatively large area. Particularly in an X-ray metal grating structure utilizing a silicon wafer, it is possible to utilize a relatively large silicon wafer having a diameter, for example, of 300 or 400 mm. However, currently, a widely-distributed and easily-available silicon wafer having high compatibility with an etching apparatus has a diameter of about 8 inches, so that a resulting X-ray metal grating structure has a square shape, e.g., about 120 or 130 mm on a side. In the case where a diagnostic X-ray imaging device is constructed using an X-ray metal grating structure utilizing a silicon wafer having such a size, it becomes necessary to dispose a plurality of X-ray metal grating structures side-by-side in order to cope with an imaging area of a rectangle, for example, having a short-side length of about 250 mm. However, the manufacturing method for the X-ray metal grating structure 1a pertaining to the first embodiment is capable of manufacturing a relatively large-area X-ray metal grating structure 1a, as mentioned above, so that it becomes possible to manufacture a single piece of X-ray metal grating structure 1a capable of coping with the above imaging area.

In the manufacturing method for the X-ray metal grating structure 1a pertaining to the first embodiment, each of the plurality of pores extends in the thickness direction of the metal substrate 13a. Each of the plurality of pores formed by an anodic oxidation process can have a relatively large length, for example, of several mm. In the manufacturing method for the X-ray metal grating structure 1a pertaining to the first embodiment, each of the plurality of pores extends in the thickness direction of the metal substrate 13a, so that it becomes possible to form each of the recesses, i.e., X-ray transmissible portions 112a, to have a high aspect ratio, for example, of 5 or more.

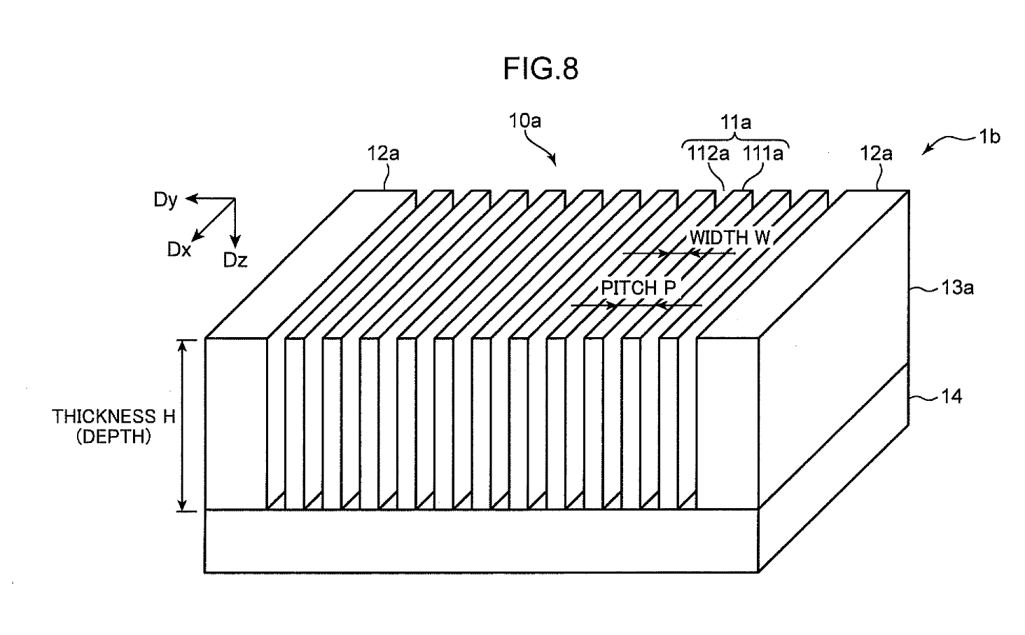

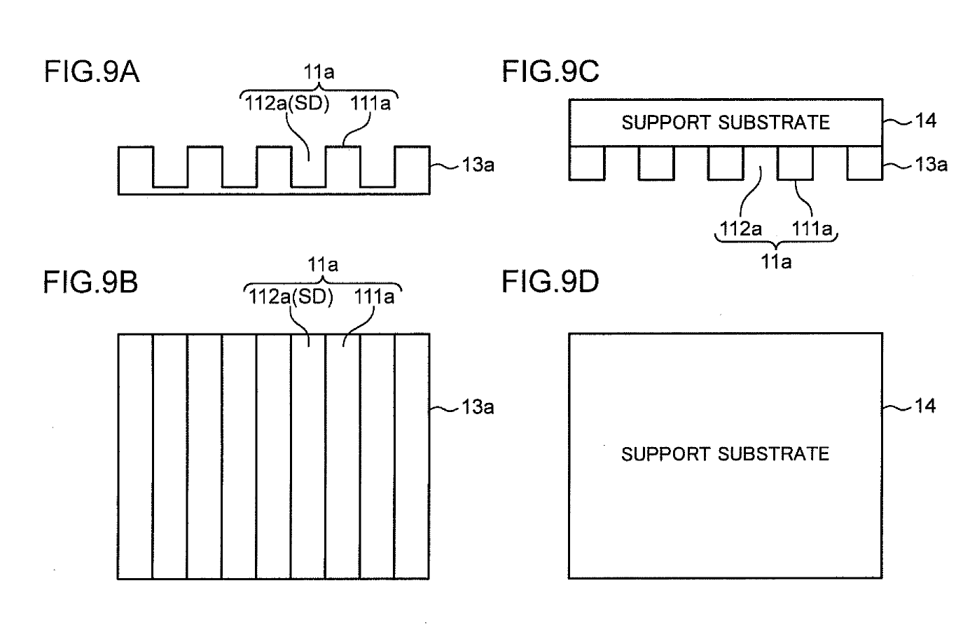

It should be understood that each of the recesses (X-ray transmissible portions 112a) may be a through-hole penetrating through the metal substrate 13a in the thickness direction of the metal substrate 13a. The X-ray metal grating structure 1a having a plurality of through-holes serving as the recesses (X-ray transmissible portions 112a), pertaining to one modification of the first embodiment, is manufactured by performing the aforementioned steps and further performing the following steps. FIG. 8 is a perspective view depicting a configuration of an X-ray metal grating structure pertaining to one modification of the first embodiment. FIGS. 9A to 9D are diagrams illustrating a second manufacturing method for the X-ray metal grating structure pertaining to the modification of the first embodiment. In FIGS. 9A to 9D, FIG. 9A and FIG. 9B are used in combination to schematically illustrate one of a plurality of manufacturing steps, wherein FIG. 9A is a sectional view of FIG. 9B, and FIG. 9B is a top view. FIG. 9C and FIG. 9D are used in combination to schematically illustrate one of a plurality of manufacturing steps, wherein FIG. 9C is a sectional view of FIG. 9D, and FIG. 9D is a top view.

In the manufacturing method for the X-ray metal grating structure 1a pertaining to the first embodiment, the grating region 10a formed with the grating 11a, and the rim region 12a surrounding the grating region 10a, are integrally formed in the metal substrate 13a, as described with reference to FIG. 1. On the other hand, in the X-ray metal grating structure 1b pertaining to the modification of the first embodiment, a grating region 10a formed with a grating 11a, and a rim region 12a surrounding the grating region 10a, are disposed on one principle surface of a support substrate 14, as depicted in FIG. 8. In the X-ray metal grating structure 1b pertaining to the modification of the first embodiment, each of a plurality of X-ray transmissible portions 112a penetrates through a metal substrate 13a in a thickness direction (Dz direction) of the metal substrate 13a. Thus, except that bottoms of the X-ray transmissible portions 112a are defined by the one principal surface (a partial region of the one principal surface) of the support substrate 14, the grating region 10a formed with the grating 11a and the rim region 12a in the X-ray metal grating structure 1b pertaining to this modification are the same, respectively, as the grating region 10a formed with the grating 11a and the rim region 12a in the X-ray metal grating structure 1b pertaining to the first embodiment. Therefore, descriptions thereof will be omitted.

In the manufacturing method for the X-ray metal grating structure 1b pertaining to the modification, depicted in FIG. 8, after the recess forming step depicted in FIGS. 5C and 5D, the resist layer 131 (in the aforementioned example, the silica films 131-1, 131-2) are removed by means of dissolution using, for example, a dissolving solution suitable for a material of the resist layer 131 (FIGS. 9A and 8B; resist layer removal step).

Subsequently, the support substrate 14 is fixed to one of opposite principal surfaces of the metal substrate 13a in which the recesses are opened, for example, by an adhesive, and the other principal surface of the metal substrate 13a which is located on the side of closed ends of the recesses SD (112a) is cut, for example, by grinding, until a cutting depth reached the recesses SD to establish penetration of the recesses SD (FIGS. 9C and 9D). The support substrate 14 is a plate-shaped member for supporting the grating region 10a and the frame region 12a, and formed of a material having a high X-ray transmissibility, such as a resin material including acrylic resin. In this way, the X-ray metal substrate structure 1b depicted in FIG. 8 is manufactured.

In the manufacturing method for this type of X-ray metal grating structure 1b, each of the recesses SD (X-ray transmissible portions 112a) is a through-hole, i.e., a part of the metal substrate (in the aforementioned example, molybdenum having an X-ray absorbability) defining the bottoms of the recesses SD (X-ray transmissible portions 112a) is eliminate. This makes it possible to manufacture a higher-performance X-ray metal grating structure 1b. That is, in this modification, it becomes possible to manufacture an X-ray metal grating structure 1b having a high X-ray transmissibility.

Next, another embodiment will be described.

### Second Embodiment

### X-Ray Metal Grating Structure

In the first embodiment, the metal substrate 13a is formed of a metal (including an alloy) having a high X-ray absorbability (X-ray absorbing property). Differently, in a second embodiment, the metal substrate 13a is formed of a metal (including an alloy) having a high X-ray transmissibility (X-ray transmitting property).

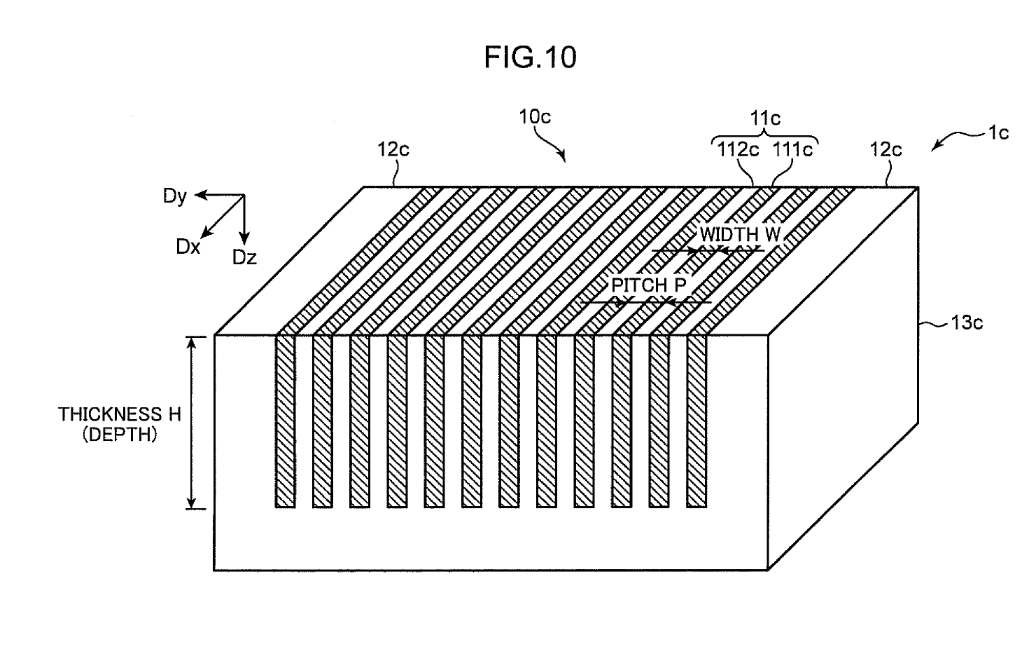

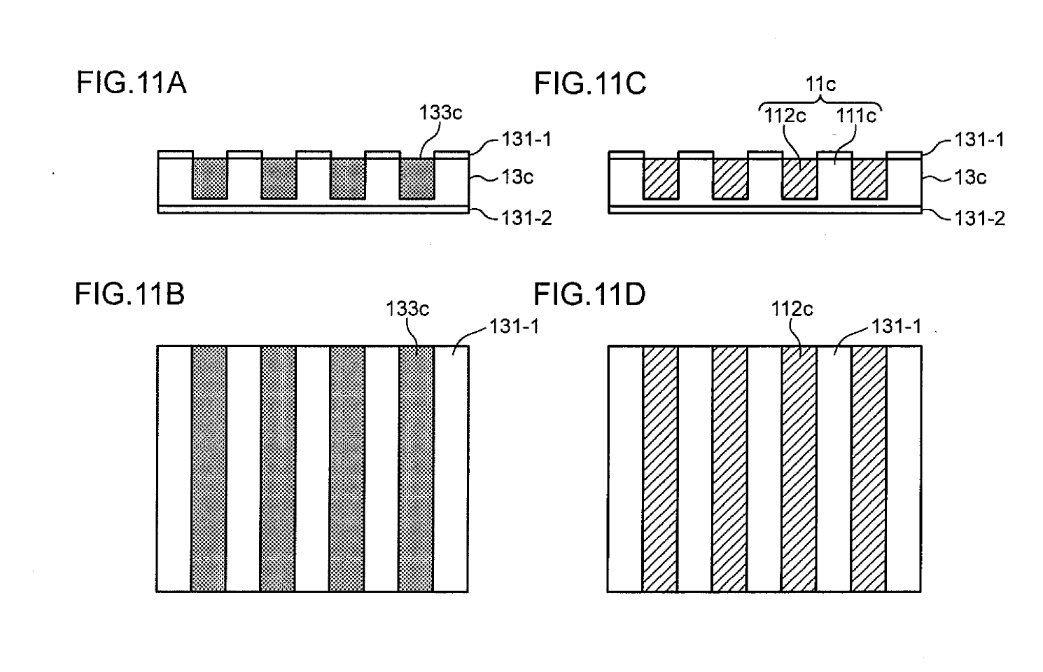

FIG. 10 is a perspective view depicting a configuration of an X-ray metal grating structure pertaining to the second embodiment. FIGS. 11A to 11D are diagrams illustrating a third manufacturing method for the X-ray metal grating structure pertaining to the second embodiment. In FIG. 11A to 11D, FIG. 11A and FIG. 11B are used in combination to schematically illustrate one of a plurality of manufacturing steps, wherein FIG. 11A is a sectional view of FIG. 11B, and FIG. 11B is a top view. FIG. 11C and FIG. 11D are used in combination to schematically illustrate one of a plurality of manufacturing steps, wherein FIG. 11C is a sectional view of FIG. 11D, and FIG. 11D is atop view.

As depicted in FIG. 10, the metal grating structure 1c pertaining to the second embodiment is constructed in such a manner that it has a grating region 10c and a rim region 12c each provided in a metal substrate 13c. The grating region 10a is a region formed with a grating 11c, and the rim region 12c is surroundingly provided around the grating region 10c.

In the X-ray metal grating structure 1a pertaining to the first embodiment, each of the X-ray absorbable portions 111a is a plate-shaped or layer-shaped member formed from the metal substrate 13a by performing the steps depicted in FIG. 2A to 5D, to extend along the plane Dx-Dz, and each of the X-ray transmissible portions 12a is a plate-shaped or layer-shaped apace (slit groove) formed from the metal substrate 13a by performing the steps depicted in FIG. 2A to 5D, to extend along the plane Dx-Dz. On the other hand, in the X-ray metal grating structure 1c pertaining to the second embodiment, each of a plurality of X-ray absorbable portions 111c is a member made of a metal material having a high X-ray absorbability and implanted in a plate-shaped or layer-shaped space (slit groove) formed from the metal substrate 13c by performing aftermentioned steps, to extend along the plane Dx-Dz, and each of a plurality of X-ray transmissible portions 112c is a plate-shaped or layer-shaped member formed from the metal substrate 13c by performing the aftermentioned steps, to extend along the plane Dx-Dz. Except for this point, the grating region 10c formed with the grating 11c, and the rim region 12c, in the X-ray metal grating structure 1c pertaining to the second modification are the same, respectively, as the grating region 10a formed with the grating 11a, and the rim region 12a, in the X-ray metal grating structure 1a pertaining to the first embodiment. Therefore descriptions thereof will be omitted. The X-ray absorbable portions 111c and the X-ray transmissible portions 112c in the grating 11c correspond, respectively, to the X-ray absorbable portions 111a and the X-ray transmissible portions 112a in the grating 11a.

This X-ray metal grating structure 1c is manufactured by a method comprising: a resist layer forming step of forming a resist layer (protective layer) on at least one of opposite principal surfaces of a metal substrate, wherein the metal substrate is formed of a first metal having a first property in terms of X-rays; a patterning step of patterning the resist layer (protective layer) and removing the patterned portion of the resist layer (protective layer); an anodic oxidation step of forming a plurality of pores in a portion of the metal substrate corresponding to the removed portion of the resist layer (protective layer), by anodic oxidation process; a recess forming step of removing the portion formed with the plurality of pores to form a recess; and a metal implantation step of implanting, into the recess, a second metal having a second property different from the first property, in terms of X-rays. For example, the recess may be formed as a slit groove in a one-dimensional grating structure, or may be formed as a columnar-shaped hole (columnar-shaped bore) in a two-dimensional grating structure. The following description will be made about details of the manufacturing method for the X-ray metal grating structure 1c in the case where the recess is formed as a slit groove. It should be noted that the details may also be applied to the case where the recess is formed in another configuration such as a columnar-shaped hole.

For manufacturing the X-ray metal grating structure 1c pertaining to the second embodiment, first of all, a plate-shaped metal substrate 13c is preliminarily provided. The metal substrate 13c is formed of a metal (including an alloy) capable of allowing a plurality of pores to be formed therein by an anodic oxidation process in the anodic oxidation step. In this manufacturing method, the metal substrate 13c is formed of a metal (including an alloy) having a high X-ray transmissibility, i.e., high ability of transmitting X-rays, because a portion remaining after the anodic oxidation step and the recess forming step is formed as an X-ray transmissible portion 112c of the grating 11c, as described later. From viewpoints of the anodic oxidation process and the high X-ray transmissibility, the metal substrate 13c is formed of a metal such as aluminum (Al). In this example, the metal substrate 13c is formed of aluminum.

Then, the resist layer forming step (protective layer forming step), the patterning step, the anodic oxidation step and the recess forming step are performed in the same manner as the patterning step, the anodic oxidation step and the recess forming step described with reference to FIGS. 2C and 2D, and FIGS. 3A to 5D.

Considering that the metal substrate 13c is aluminum, in this anodic oxidation step, for example, a 0.1 M oxalic acid solution is used as an electrolyte solution 24, and a DC voltage of about 20V is applied between a cathode electrode 22 and the metal substrate 13c, for about 10 hours. As a result, in a portion of the metal substrate 13c from which a silica film 131-1 serving as the resist layer (protective layer) has been removed, a plurality of pores each having a diameter φ of about 40 nm and a depth H of about 80 μm are formed with an average distance of about 60 nm between adjacent ones thereof (FIGS. 11A and 11B).

The metal substrate 13c processed through the resist layer forming step, the patterning step and the anodic oxidation step is provided as an intermediate product of the X-ray metal grating structure, includes: an X-ray transmissible portion 112c formed of the metal substrate having an X-ray transmissibility, i.e., an ability of transmitting X-rays, and provided in a given first region of the metal substrate; and a pored portion 133c comprised of the plurality of pores and formed in a given second region, except for the X-ray transmissible portion 112c, wherein at least one of the X-ray transmissible portion 112c and the pored portion 133c is provided plurally and periodically. Each of the plurality of pores extends in a thickness direction of the metal substrate 13c to an inside of the metal substrate 13c or penetratingly.

In the recess forming step, for example, by using, as a dissolving solution, a solution containing phosphoric acid in a concentration of 5 weight % to dissolve aluminum oxide, the portion 133c formed with the plurality of pores is removed to form a slit groove-shaped recess SD (depiction is omitted).

Then, after completion of the recess forming step, the second metal having the second property in terms of X-rays which is different from the first property of the first metal forming the metal substrate 13c is implanted into the recess SD (metal implantation step; FIGS. 11C and 11D). In the second embodiment, the metal substrate 13c is formed of a metal having an X-ray transmissibility to serve as the first metal, and thus the second metal is a metal having an X-ray absorbability. Examples of the second metal having an X-ray absorbability include a metal of an element having a relatively heavy atomic weight, and a noble metal, and, more specifically, include gold (Au), platinum (Pt), rhodium (Rh), ruthenium (Ru) and iridium (Ir).

More specifically, a plurality of metal particles are implanted from an opening of the recess SD into the recess SD (vibration process). More specifically, the metal substrate 13c processed through the above steps is fixed to a bottom surface of a container, and a solid gold power having a tap density of about 8 g/cc and a particle size of about 0.2 to 1.0 μm is put in the container. Then, a vibration of about 10 Hz is applied to the container by a vibration generator for generating vibration, so that the metal substrate 13c is vibrated through the container. As a result, gold is implanted into the slit groove-shaped recess SD to form the X-ray absorbable portion 111c.

A process for realizing the metal implantation step is not limited to the vibration process, but may be any other suitable process capable of implanting the second metal into the recess SD. For example, the process for realizing the metal implantation step may be a supercritical fluid chemical deposition process. This supercritical fluid chemical deposition process is a heretofore-known technique disclosed, for example, in JP 2013-124959A, wherein the process generally includes: a supercritical fluid forming step of causing a solvent to undergo a phase transition to a supercritical fluid; a dissolving step of dissolving, as a solute, a metal compound containing an element of the second metal, in a solvent consisting of the supercritical fluid; an introduction step of introducing the metal compound dissolved in the solvent consisting of the supercritical fluid, into the recess SD; and a precipitation step of precipitating the metal from the metal compound introduced in the recess SD. Alternatively, the process for realizing the metal implantation step may be an electroforming process as heretofore-known commonplace means. Alternatively, the process for realizing the metal implantation step may be a coating and filling process. This coating and filling process includes coating and filling a metal paste containing a plurality of particles of the second metal, from the opening of the recess SD into the recess.

Through the above manufacturing steps, the X-ray metal grating structure 1c having the configuration depicted in FIG. 10 is manufactured.

In the second embodiment, the first metal is a metal (including an alloy) having an X-ray transmissibility, and the second metal is a metal (including an alloy) having an X-ray absorbability. Alternatively, the first metal may be a metal (including an alloy) having, as the first property, a low phase-shifting property, i.e., a property capable of achieving only a relatively small phase-shifting amount, and the second metal may be a metal (including an alloy) having, as the second property, a high phase-shifting property, i.e., a property capable of achieving a relatively large phase-shifting amount (a phase-shifting amount greater than that of the first metal).

The manufacturing method for the X-ray metal grating structure 1c pertaining to the second embodiment (including any modification thereof) has the same functions and advantage effects as those in the first embodiment. In addition, the manufacturing method for the X-ray metal grating structure 1c pertaining to the second embodiment additionally includes the metal implantation step. Thus, by using, as the second metal, a metal material (including an alloy material) having, as the second property, an X-ray absorbability or a high phase-shifting property, a metal material (including an alloy material) having, as the first property, an X-ray transmissibility or a low phase-shifting property can be utilized as the first metal.

It should be noted that, although the X-ray metal grating 1 (1a, 1b, 1c) in the first and second embodiments (including any modification thereof) has a one-dimensional periodic structure, it is not limited thereto. For example, the X-ray metal grating 1 may be a grating having a two-dimensional periodic structure. For example, a two-dimensional periodic structured X-ray metal grating is configured such that dots indicative of a two-dimensional periodic structured member are arranged at even intervals of a given distance in two linear independent directions. Such a two-dimensional periodic structured X-ray metal grating can be formed by making a plurality of holes each having a high aspect ratio, in a planar surface in a two-dimensional period, or by standingly providing a plurality of columns each having a high aspect ratio, in a planar surface in a two-dimensional period. Further, a metal may be implanted into these spaces in the same manner as that described above.

Preferably, in the first and second embodiments (including any modification thereof), each of the plurality of pores is formed in such a manner as to satisfy the following relationship: Ph≦dW, where: W denotes a width of the recess; dW denotes an allowable error (±) of the recess; and Ph denotes a distance between adjacent ones of the plurality of pores (between centers of adjacent ones of the plurality of pores), proportional to an applied voltage V during the anodic oxidation process.

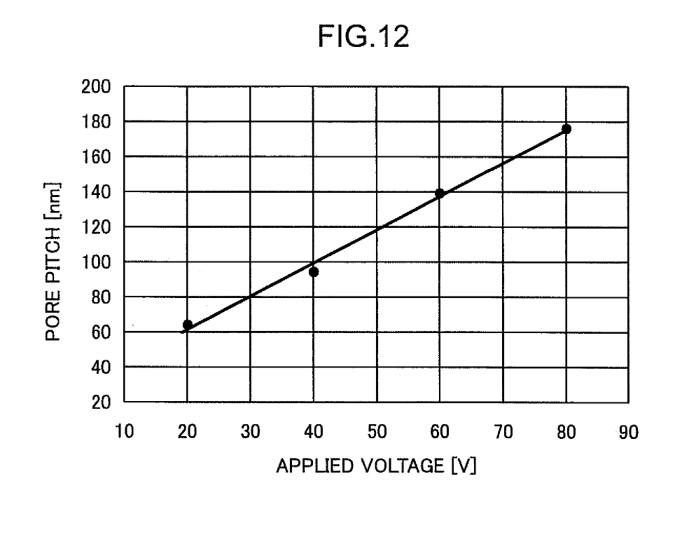

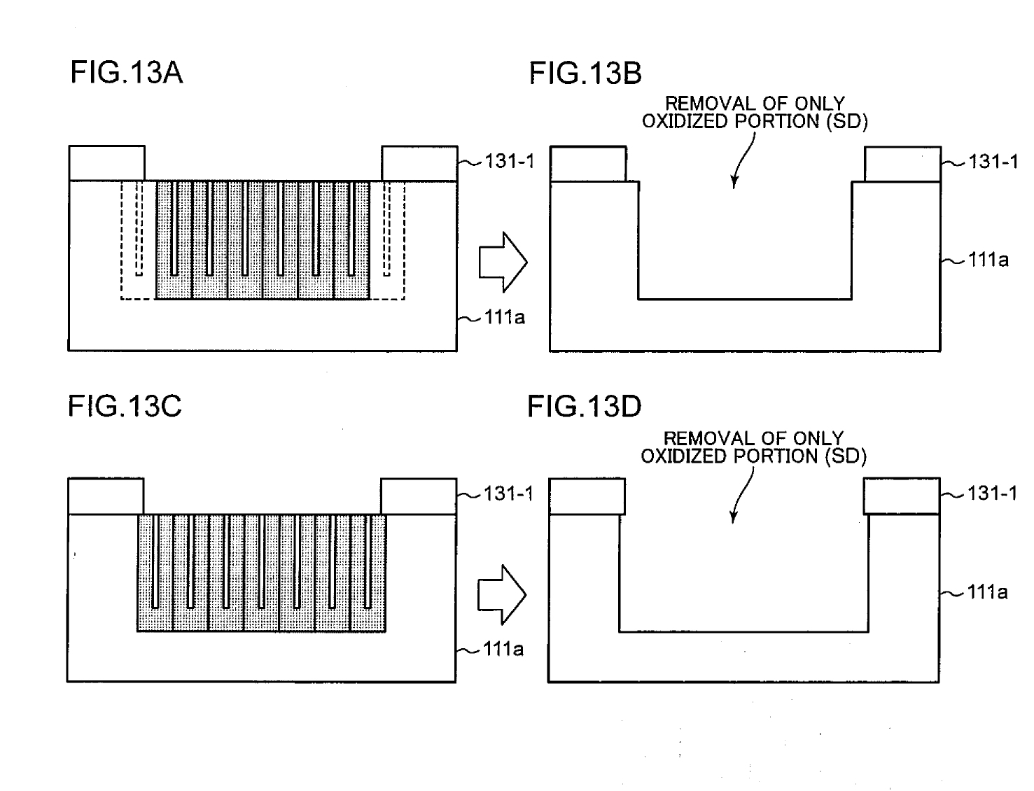

FIG. 12 is a graph illustrating a relationship between an applied voltage in the anodic oxidation process and a resulting pore pitch. In FIG. 12, the horizontal axis represents an applied voltage expressed by V, and the vertical axis represents a pore pitch expressed by mm. FIGS. 13A to 13D are diagrams illustrating a relationship between a width of the recess and a pore pitch. FIG. 13A depicts a first example of the plurality of pores formed by the anodic oxidation process, and FIG. 13B depicts a slit groove-shaped recess formed by removing the portion formed with the plurality of pores depicted in FIG. 13A. FIG. 13C depicts a second example of the plurality of pores formed by the anodic oxidation process, and FIG. 13D depicts a slit groove-shaped recess formed by removing the portion formed with the plurality of pores depicted in FIG. 13C.

The applied voltage V in the anodic oxidation process and the resulting pore pitch have a given relationship therebetween. In the anodic oxidation process, an electron transfer distance within an oxidized metal is approximately proportional to the applied voltage V. Thus, the pore pitch Ph is proportional to the applied voltage under a given proportionality coefficient, and a metal is evenly oxidized in a circular range defined by a radius extending from a center of the pore, wherein the radius is based on the given proportionality coefficient. For example, in anode oxidation of aluminum using oxalic acid, as depicted in FIG. 12, the pore pitch is proportional to the applied voltage under a proportionality coefficient (gradient) of about 2 nm/V.

At such a pore pitch Ph, the plurality of pores are formed in a portion of the metal substrate 13a (13c) corresponding to a removed portion of a resist layer (m the aforementioned example, the silica film 131-1), by the anodic oxidation process. However, in the above first and second embodiments, formation positions of the pores are not regulated, and thus become arbitrary. Therefore, there occurs a situation where the metal substrate 13a (13c) is not oxidized over the entire portion from which the resist layer has been removed, i.e., unoxidized metal regions (region indicated by the broken lines in FIG. 13A) are left, respectively, on opposite sides of the portion from which the resist layer has been removed, as depicted in FIG. 13A (first case), or a situation where the metal substrate 13a (13c) is oxidized over the entire portion from which the resist layer has been removed, as depicted in FIG. 13C (second case), by the anodic oxidation in the anodic oxidation process. In the first case, unoxidized metal regions are left, respectively, on the opposite sides of the portion from which the resist layer has been removed. Thus, after the completion of the subsequent recess forming step, the metal regions remain as depicted in FIG. 13B, so that the width W of the slit groove-shaped recess SD becomes narrower than a width of the portion from which the resist layer has been removed (i.e., a design width W of the recess SD). On the other hand, in the second case, the metal substrate 13a (13c) is oxidized over the entire portion from which the resist layer has been removed. Thus, after the completion of the subsequent recess forming step, the width W of the slit groove-shaped recess SD becomes equal to the width of the portion from which the resist layer has been removed (i.e., the design width W of the recess SD). It should be noted that, in FIG. 13, for the sake of convenience of depiction and facilitation of understanding, design dimensions are supposed as follows: the width W of the slit groove-shaped recess SD=4 μm; and the pore pitch Ph depending on the applied voltage V=600 nm (W=4 μm, Ph-600 nm). Under this supposition, in the first case depicted in FIG. 13A, six pores are formed over a width of 3.6 μm (=600 nm×6) in a region of the metal substrate 13a (13c) corresponding to the removed portion of the resist layer, and unoxidized metal portions each having a width of 0.2 μm are left, respectively, on the opposite sides of the portion from which the resist layer has been removed. Therefore, when the recess forming step is performed, the width of the slit groove-shaped recess SD depicted in FIG. 13B becomes 3.6 μm. On the other hand, under the above supposition, in the second case depicted in FIG. 13C, seven pores are formed over a width of 4.2 μm (=600 nm×7) in the region of the metal substrate 13a (13c) corresponding to the removed portion of the resist layer, and the metal substrate 13a (13c) is oxidized over the entire portion from which the resist layer has been removed. Therefore, when the recess forming step is performed, the width of the slit groove-shaped recess SD depicted in FIG. 13D becomes 4.2 μm.

As above, in the case where the formation position of the plurality of pores to be formed by the anodic oxidation process is not regulated, differently from the Literature 1, the width of the recess SD varies by a length corresponding to approximately one pore pitch. Therefore, it is preferable that each of the plurality of pores is formed in such a manner as to satisfy the relationship Ph≦dW, as mentioned above. That is, the applied voltage V in the anodic oxidation process during the anodic oxidation step is preferably set to satisfy the relationship Ph≦dW. This makes it possible to accurately form the recess within a design range of W±dW.

Alternatively, the formation position of the plurality of pores to be formed by the anodic oxidation process may be regulated in the same manner as that in the Literature 1. This makes it possible to exactly and accurately form the recess SD.

In the manufacturing method for the X-ray metal grating structure 1 (1a, 1b, 1c) pertaining to the first and second embodiments (including any modification thereof), the plurality of pores may be formed such that, when an X-ray source configured to radiate X-rays and intended to be disposed in conformity to the X-ray metal grating structure manufactured by this manufacturing method is disposed at a given position with respect to the X-ray metal grating structure 1, the plurality of pores extend so as to converge toward a focal point of the X-rays radiated from the X-ray source. As disclosed in the Literature 1, such a plurality of pores can be formed by, in each of the resist layers (131-1, 131-2) formed on the opposite principal surfaces of the metal substrate 13 (13a, 13c), displacing positions of a plurality of portions to be removed, from each other.

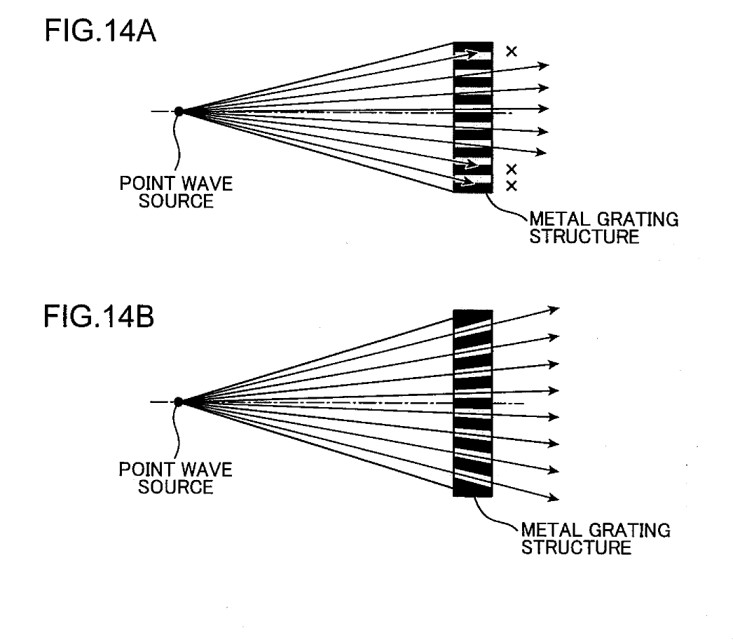

FIGS. 14A and 14B are diagrams illustrating vignetting of X-rays radiated from an X-ray source, in an X-ray metal grating structure. FIG. 14A depicts an X-ray metal grating structure having a plurality of recesses (X-ray transmissible portions) extending a normal direction, wherein the plurality of recesses are formed by removing a plurality of portions each formed with a plurality of pores and extending in the normal direction, and FIG. 14B depicts an X-ray metal grating structure having a plurality of recesses (X-ray transmissible portions) extending so as to converge toward a focal point of X rays, wherein the plurality of recesses are formed by removing a plurality of portions each formed with a plurality of pores and extending so as to converge toward the focal point of the X rays. Generally, an X-ray source is a point wave source, and operable to radiate X-rays in a radial pattern, as depicted in FIG. 14. Thus, in the case where the X-ray metal grating structure is a flat plate, and each of the plurality of pores extends along the normal direction, wherein the X-ray source is disposed on a normal line passing through a center of the X-ray metal grating structure, the X-rays enter each of the recesses (X-ray transmissible portions) formed by removing the portions each formed with the plurality of pores at an oblique angle which gradually increases in a direction from the center toward an outer periphery of the X-ray metal grating structure, as illustrated in FIG. 14A. As a result, so-called “vignetting” undesirably occurs. In the above manufacturing method for the X-ray metal grating structure, the plurality of pores are formed to extend so as to converge toward the focal point of the X-rays. This makes it possible to suppress the vignetting.

### Third and Fourth Embodiments

### Talbot Interferometer and Talbot-Lau Interferometer

The X-ray metal grating structure 1 (1a, 1b, 1c) pertaining to the above embodiments makes it possible to form a metal portion with a high aspect ratio. An X-ray Talbot interferometer and an X-ray Talbot-Lau interferometer using the metal grating structure 1 will be described below.

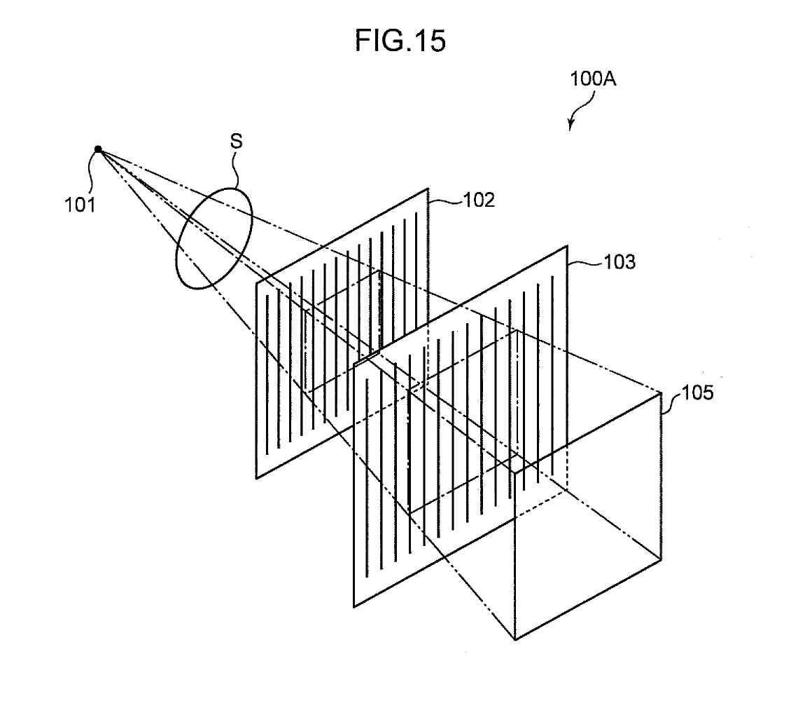

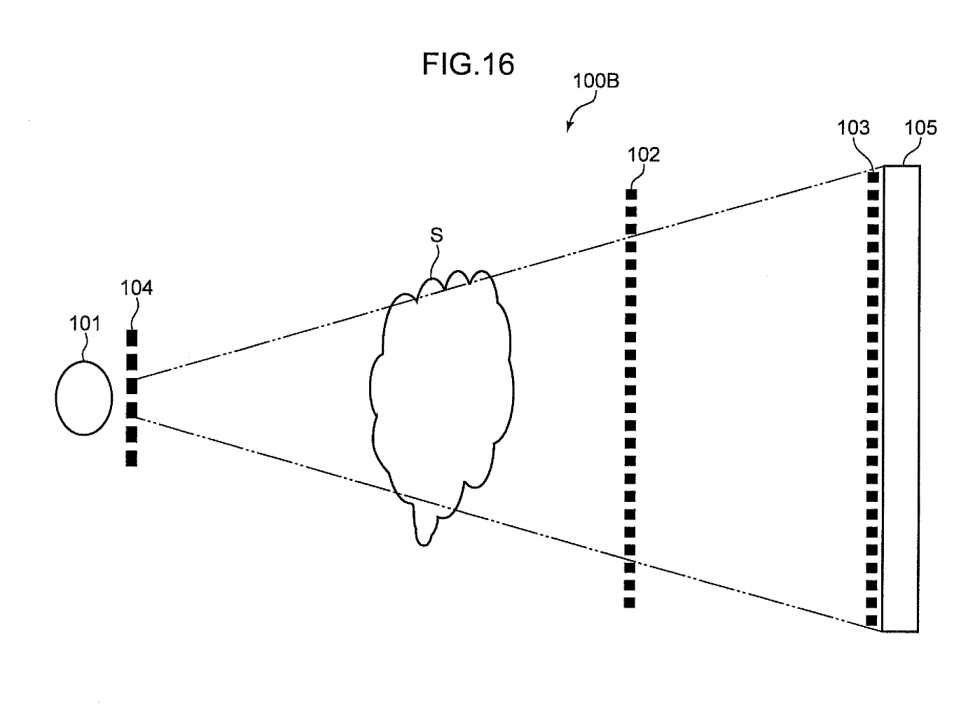

FIG. 15 is a perspective view depicting a configuration of an X-ray Talbot interferometer pertaining to a third embodiment of the present invention. FIG. 16 is a top view depicting a configuration of an X-ray Talbot-Lau interferometer pertaining to a fourth embodiment of the present invention.

As depicted in FIG. 15, the X-ray Talbot interferometer 100A pertaining to the third embodiment includes: an X-ray source 101 configured to radiate X-rays having a given wavelength; a first diffraction grating 102 which is a phase type configured to diffract the X-rays radiated from the X-ray source 101; and a second diffraction grating 103 which is an amplitude type configured to diffract the X-rays diffracted by the first diffraction grating 102 to thereby form an image contrast, wherein the first and second diffraction gratings 102, 103 are set to satisfy conditions for constructing an X-ray Talbot interferometer. The X-rays having an image contrast generated by the second diffraction grating 103 are detected, for example, by an X-ray image detector 105 operable to detect X-rays. In the X-ray Talbot interferometer 100A, at least one of the first diffraction grating 102 and the second diffraction grating 103 has the aforementioned X-ray metal grating structure 1.

The conditions for constructing the Talbot interferometer 100A are expressed by the following formulas 1, 2. The formula 2 is based on an assumption that the first diffraction grating 102 is a phase-type diffraction grating.

I=λ/(a/(L+Z1+Z2)) formula (1)

Z1=(m+1/2)×(d²/λ) formula (2)

where: I denotes a coherence length; λ denotes a wavelength of X-rays (generally, center wavelength); a denotes an aperture diameter of the X-ray source 101 in a direction approximately orthogonal to a diffraction member of a diffraction grating; L denotes a distance from the X-ray source 101 to the first diffraction grating 102; Z1 denotes a distance from the first diffraction grating 102 to the second diffraction grating 103; Z2 denotes a distance from the second diffraction grating 103 to the X-ray image detector 105; m denotes an integer; and d denotes a period of a diffraction member (a period of a diffraction grating, a grating constant, a distance between centers of adjacent diffraction members, or the pitch P).

In the X-ray Talbot interferometer 100A having the above configuration, X-rays are radiated from the X-ray source 101 toward the first diffraction grating 102. The radiated X-rays produce a Talbot effect through the first diffraction grating 102 to thereby form a Talbot image. The Talbot image forms an image contrast having moire fringes by an action received through the second grating 103. Then, the image contrast is detected by the X-ray image detector 105.

The Talbot effect means that, upon incidence of light onto the diffraction grating, an image identical to the diffraction grating (a self image of the diffraction grating) is formed at a position away from the diffraction grating by a certain distance, wherein the certain distance is called “Talbot distance L” and the self image is called “Talbot image”. In the case where the diffraction grating is a phase-type diffraction grating, the Talbot distance L becomes Z1 (L=Z1) as expressed by the formula 2. The Talbot image appears as a reverted image when the Talbot distance is equal to an odd multiple of L (=(2 m+1), where each of L and m is an integer), and appears as a normal image when the Talbot distance is equal to an even multiple of L (=2 mL).

In the case, when a subject S is disposed between the X-ray source 101 and the first diffraction grating 102, the moire fringes are modulated by the subject S, and an amount of the modulation is proportional to an angle at which X-rays are bent by a refraction effect arising from the subject S. Thus, the subject S and an internal structure of the subject S can be detected by analyzing the moire fringes.

In the Talbot interferometer 100A configured as depicted in FIG. 15, the X-ray source 101 is a single spot light source. Such a single spot light source can be constructed by additionally providing a single slit plate formed with a single slit. X-rays radiated from the X-ray source 101 pass through the single slit of the single slit plate, and is radiated toward the first diffraction grating 102 through the subject S. The slit is an elongate rectangular opening extending in one direction.

On the other hand, as depicted in FIG. 16, a Talbot-Lau interferometer 100B is constructed in such a manner that it includes: an X-ray source 101; a multi-slit plate 104; a first diffraction grating 102; and a second diffraction grating 103. Specifically, the Talbot-Lau interferometer 100B is constructed in such a manner that it includes, in addition to the Talbot interferometer 100A depicted in FIG. 15, the multi-slit plate 104 having a plurality of slits formed in parallel relation, on an X-ray radiation side of the X-ray source 101.

The multi-slit plate 104 is a so-called zeroth grating, and may be the X-ray metal grating structure 1 manufactured by any one of the manufacturing methods for the X-ray metal grating structure 1. When the multi-slit plate 104 is manufactured by any one of the manufacturing methods for the X-ray metal grating structure, it becomes possible to transmit X-rays through the slit-shaped X-ray transmissible portions 112 (112a, 112c) while more reliably blocking X-rays by the slit-shaped X-ray absorbable portions 111 (111a, 111c), and thus more clearly discriminate between transmittance and non-transmittance of X-rays. This allows the multi-slit plate 104 to more reliably convert X-rays radiated from the X-ray source 101 into a multi-light source.

When the Talbot-Lau interferometer 100B is used, an X-ray dose irradiated toward the first diffraction grating 102 through the subject S is increased, as compared to the Talbot interferometer 100A, so that it becomes possible to obtain better moire fringes.

### Fifth Embodiment

### X-Ray Imaging Device

The X-ray metal grating structure 1 (1a, 1b, 1c) is utilizable in a variety of optical device, and suitably used, for example, in an X-ray imaging device, because the X-ray absorbable portions 111 (111a, 111c) can be formed with a high aspect ratio. In particular, an X-ray imaging device using an X-ray Talbot interferometer is one phase contrast method designed to handle X-rays as waves and detect a phase shift occurring when X-rays penetrating through a subject to obtain a transmission image of the subject, so that it has an advantage of being able to expect to improve sensitivity about 1,000 times, as compared to an absorption contrast method designed to obtain an image by utilizing differences in magnitudes of X-ray absorption by a subject as contrast, thereby reducing an X-ray dose, for example, to 1/100 to 1/1000. In this embodiment, an X-ray imaging device equipped with an X-ray Talbot interferometer using the aforementioned X-ray metal grating 1 will be described.

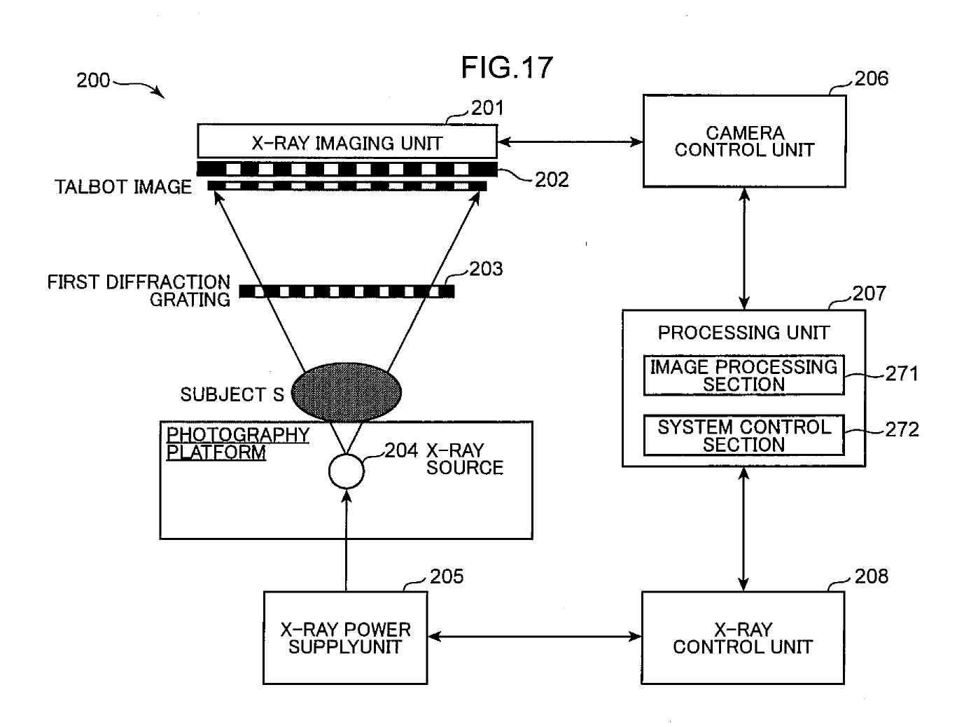

FIG. 17 is an explanatory diagram depicting a configuration of an X-ray imaging device pertaining to a fifth embodiment of the present invention. In FIG. 17, the X-ray imaging device 200 includes: an X-ray imaging unit 201; a second diffraction grating 202; a first diffraction grating 203; and an X-ray source 204. The X-ray imaging device 200 pertaining to this embodiment further includes: an X-ray power supply unit 205 for supplying electricity to the X-ray source 204; a camera control unit 206 for controlling an imaging operation of the X-ray imaging unit 201; a processing unit 207 for controlling an overall operation of the X-ray imaging device 200; and an X-ray control unit 208 for controlling an electricity supply operation by the X-ray power supply unit 205 to thereby control an X-ray radiation operation by the X-ray source 204.

The X-ray source 204 is a device operable, in response to receiving electricity supplied from the X-ray power supply unit 205, to radiate X-rays toward the first diffraction grating 203. For example, the X-ray source 204 is a device configured such that a high voltage supplied from the X-ray power supply unit 205 is applied between a cathode and an anode, and electrons released from a filament of the cathode collide with the anode to thereby radiate X-rays.

The first diffraction grating 203 is a diffraction grating configured to produce a Talbot effect by X-rays radiated from the X-ray source 204. For example, the first diffraction grating 203 is a diffraction grating manufactured by any one of the manufacturing methods for the X-ray metal grating structure 1. The first diffraction grating 203 is set to satisfy conditions for producing a Talbot effect, and is a phase-type diffraction grating having a sufficiently coarse grating with respect to a wavelength of X-rays radiated from the X-ray source 204, for example, having a grating constant (a period of a diffraction grating) d of about 20 times or more of the wavelength of the X-rays. The first diffraction grating 203 may be an amplitude-type diffraction grating equivalent thereto.

The second diffraction grating 202 is a transmission and amplitude-type diffraction grating disposed at a position away from the first diffraction grating 203 approximately by a Talbot distance L, to diffract X-rays diffracted by the first diffraction grating 203. As with the first diffraction grating 203, the second diffraction grating 202 is also a diffraction grating manufactured by any one of the manufacturing methods for the X-ray metal grating structure 1.

The first and second diffraction gratings 203, 202 are set to satisfy conditions for constructing a Talbot interferometer expressed by the aforementioned formulas 1 and 2.

The X-ray imaging unit 201 is a device for imaging an image of X-rays diffracted by the second diffraction grating 202. For example, the X-ray imaging unit 201 is a flat panel detector (FPD) comprising a two-dimensional image sensor in which a thin film layer containing a scintillator for absorbing X-ray energy and emitting fluorescence is formed on a light receiving surface or an image intensifier camera comprising: an image intensifier unit for converting incident photons into electrons by a photoelectric surface, and after doubling the electrons by a micro-channel plate, causing the group of doubled electron to collide with a fluorescent material to generate fluorescence; and a two-dimensional image sensor for imaging output light from the image intensifier unit.

The processing unit 207 is a device for by controlling units of the X-ray imaging device 200 to thereby control the overall operation of the X-ray imaging device 200. For example, the processing unit 207 is constructed in such a manner that it includes a microprocessor and peripheral circuits thereof, and functionally includes an image processing section 271 and a system control section 272.

The system control section 272 is operable to transmit and receive control signals with respect to the X-ray control unit 208 to thereby control an X-ray radiation operation of the X-ray source 204 through the X-ray power supply unit 205, and transmit and receive control signals with respect to the camera control unit 206 to thereby control an imaging operation of the X-ray imaging unit 201. Under control of the system control section 272, X-rays are irradiated toward the subject S. Then, a resulting image is taken by the X-ray imaging unit 201, and an image signal is input into the processing unit 207 via the camera control unit 206.

The image processing section 271 is operable to process the image signal generated by the X-ray imaging unit 201, and generate an image of the subject S.

An operation of the X-ray imaging device pertaining to this embodiment will be described below. For example, a subject S is placed on a photography platform provided with the X-ray source 204 internally (or on the back thereof), and thereby disposed between the X-ray source 204 and the first diffraction grating 203. When a user of the X-ray imaging device 200 issues an instruction for imaging the subject S, from a non-depicted operation section, the system control section 272 in the processing unit 207 outputs a control signal to the X-ray control unit 208 for radiating X-rays to the subject S. According to the control signal, the X-ray control unit 208 instructs the X-ray power supply unit 205 to supply electricity to the X-ray source 204, and thus the X-ray source 204 radiates X-rays toward the subject S.

The radiated X-rays passes through the first diffraction grating 203 through the subject S, and is diffracted by the first diffraction grating 203, whereby a Talbot image T as a self image of the first diffraction grating 203 is formed at a position away from the first diffraction grating 203 by a Talbot distance L (=Z1).

The formed Talbot image T of X-rays is diffracted by the second diffraction grating 202, and an image of resulting moire fringes is formed. The image of moire fringes is imaged by the X-ray imaging unit 201 whose parameter such as exposure time is controlled by the system control section 272.

The X-ray imaging unit 201 outputs an image signal indicative of an image of moire fringes, to the processing unit 207 via the camera control unit 206. The image signal is processed by the image processing section 271 in the processing unit 207.

The subject S is disposed between the X-ray source 204 and the first diffraction grating 203. Thus, a phase of X-rays passing through the subject S is shifted from a phase of X-rays which does not pass through the subject S. As a result, X-rays entering the first diffraction grating 203 includes distortion in a wave front thereof, and a Talbot image T is deformed accordingly. Thus, the moire fringes of an image generated by overlapping the Talbot image T and the second diffraction grating 202 undergo modulation by the subject S, and an amount of the modulation is proportional to an angle at which the X-ray is bent by a refraction effect by the subject S. Therefore, the subject S and the internal structure of the subject S can be detected by analyzing the moire fringes. Further, the subject S may be imaged from different angles so as to form a tomographic image of the subject S by X-ray computed tomography (CT).

The second diffraction grating 202 in this embodiment is the X-ray metal grating structure 1 having the X-ray absorbable portions 111 with a high aspect ratio, pertaining to each of the above embodiments. Thus, it is possible to obtain good moire fringes, thereby obtaining a highly-accurate image of the subject S.

In the above X-ray imaging device 200, a Talbot interferometer is composed of the X-ray source 204, the first diffraction grating 203, and the second diffraction grating 202. Alternatively, a Talbot-Lau interferometer may be constructed by additionally disposing the X-ray metal grating structure 1 pertaining to the aforementioned embodiments as a multi-slit member on the X-ray radiation side of the X-ray source 204. Based on such a Talbot-Lau interferometer, an X-ray dose to be radiated to the subject S can be increased, as compared to the case where a single slit member is used. This makes it possible to obtain better moire fringes, thereby obtaining a further highly-accurate image of the subject S.

In the above X-ray imaging device 200, a subject S is disposed between the X-ray source 204 and the first diffraction grating 203. Alternatively, a subject S may be disposed between the first diffraction grating 203 and the second diffraction grating 202.

In the above X-ray imaging device 200, an image of X-rays is taken by the X-ray imaging unit 201, and electronic data of the image is obtained. Alternatively, an image of X-rays may be obtained by an X-ray film.

The specification discloses the aforementioned arrangements. The following is a summary of the primary arrangements of the embodiments.

An X-ray metal grating structure manufacturing method according to an aspect includes: a resist layer forming step of forming a resist layer on at least one of opposite principal surfaces of a metal substrate; a patterning step of patterning the resist layer and removing the resulting patterned portion of the resist layer, an anodic oxidation step of forming a plurality of pores in a portion of the metal substrate corresponding to the removed portion of the resist layer, by an anodic oxidation process; and a recess forming step of removing the portion formed with the plurality of pores, to thereby form a recess. Preferably, in the X-ray metal grating structure manufacturing method, the metal substrate is formed of a metal material (including an alloy material) having an X-ray absorbability, i.e., an ability of absorbing X-rays.

The X-ray metal grating structure manufacturing method includes the recess forming step of removing the portion formed with the plurality of pores, to thereby form a recess, and therefore the connection portion as in the aforementioned Literature 1 is eliminated. This makes it possible to manufacture a higher-performance X-ray metal grating structure.

In another aspect, the above X-ray metal grating structure manufacturing method includes a metal implantation step of implanting, into the recess, a second metal having a second property different from a first property of a first metal forming the metal substrate in terms of X-rays. Preferably, in the above X-ray metal grating structure manufacturing method, the metal implantation step is one of: a vibration process of implanting a plurality of metal particles from an opening of the recess into the recess by means of vibration; a supercritical fluid chemical deposition process; an electroforming process; and a coating and filling process of coating and filling a plurality of metal particles from the opening of the recess into the recess.

The above X-ray metal grating structure manufacturing method includes the metal implantation step, so that, when a metal material (including an alloy material) having, as a second property, an X-ray absorbability or a high phase-shifting property is used as the second metal, a metal material (including an alloy material) having, as a first property, an X-ray transmissibility or a low phase-shifting property can be used as the first metal.

In another aspect, in these above X-ray metal grating structure manufacturing method, the recess forming step includes removing the portion formed with the plurality of pores, by a wet etching process, to thereby form a recess.

In a dry etching process, due to difficulty in upsizing of an etching apparatus, a size of the metal substrate to be etched is restricted by the etching apparatus. On the other hand, the X-ray metal grating structure manufacturing method employs a wet etching process in the recess forming step, and therefore it is relatively easy to upsize an etching apparatus (e.g., upsizing of a tank), so that the size of the metal substrate to be etched can be set to a relatively large value so as to manufacture an X-ray metal grating structure having a relatively large area.

In another aspect, in these above X-ray metal grating structure manufacturing method, each of the plurality of pores extends in a thickness direction of the metal substrate.

Each of the plurality of pores formed by the anodic oxidation process can have a relatively large length, for example, of several mm. In the X-ray metal grating structure manufacturing method, each of the plurality of pores extends in a thickness direction of the metal substrate, so that it becomes possible to form each of the recesses to have a high aspect ratio, for example, of 5 or more. As used here, the term “aspect ratio” means a ratio of a thickness to a width of the recess (aspect ratio=thickness/width=depth/width).

In another aspect, in these above X-ray metal grating structure manufacturing method, the recess is a through-hole penetrating through the metal substrate in a thickness direction of the metal substrate.

In the above X-ray metal grating structure manufacturing method, the recess is a through-hole, i.e., a part of the metal substrate defining a bottom of the recess is eliminate. This makes it possible to manufacture a higher-performance X-ray metal grating structure.

In another aspect, in these above X-ray metal grating structure manufacturing method, each of the plurality of pores is formed in such a manner as to satisfy the following relationship: Ph≦dW, where: W denotes a width of the recess; dW denotes an allowable error (±) of the recess; and Ph denotes a distance between adjacent ones of the plurality of pores, proportional to an applied voltage during the anodic oxidation process. The applied voltage V in the anodic oxidation process and the resulting pore pitch have a given relationship therebetween. Thus, it is preferably that the applied voltage V in the anodic oxidation process is set to satisfy the relationship Ph≦dW.

In the above X-ray metal grating structure manufacturing methods, each of the plurality of pores is formed in such a manner as to satisfy the relationship Ph≦dW, so that the recess can be accurately formed within a design range of W±dW, by removing the portion formed with the plurality of pores in the recess forming step.

In another aspect, in these above X-ray metal grating structure manufacturing method, the plurality of pores are formed such that, when an X-ray source configured to radiate X-rays and intended to be disposed in conformity to the X-ray metal grating structure manufactured by the method is disposed at a given position with respect to the X-ray metal grating structure, they extend so as to converge toward a focal point of the X-rays radiated from the X-ray source.

Generally, an X-ray source is operable to radiate X-rays in a radial pattern. Thus, in the case where the X-ray metal grating structure is a flat plate, and each of the plurality of pores extends along a normal direction, wherein the X-ray source is disposed on a normal line passing through a center of the X-ray metal grating structure, X-rays enter each of the recesses formed by removing the portion formed with the plurality of pores at an oblique angle which gradually increases in a direction from the center toward an outer periphery of the X-ray metal grating structure. As a result, so-called “vignetting” undesirably occurs. In the above X-ray metal grating structure manufacturing method, the plurality of pores are formed to extend so as to converge toward the focal point of the X-rays. This makes it possible to suppress the vignetting.

In another aspect, the X-ray metal grating structure manufacturing method is designed to manufacture an X-ray metal grating structure for use in an X-ray Talbot interferometer or an X-ray Talbot-Lau interferometer.

This makes it possible to manufacture an X-ray metal grating structure for a zeroth grating, a first grating and a second grating usable in an X-ray Talbot interferometer or an X-ray Talbot-Lau interferometer.

In another aspect, an X-ray imaging device includes: an X-ray source for radiating X-rays; a Talbot interferometer or Talbot-Lau interferometer configured to be irradiated with X-rays radiated from the X-ray source; and an X-ray imaging element for imaging X-rays from the Talbot interferometer or Talbot-Lau interferometer, wherein the Talbot interferometer or Talbot-Lau interferometer is manufactured by the above X-ray metal grating structure manufacturing method.

In this X-ray imaging device, the above high-performance metal grating structure is used as an X-ray metal grating structure constituting the Talbot interferometer or Talbot-Lau interferometer. This makes it possible to obtain a clearer X-ray image.

In another aspect, an intermediate product for an X-ray metal grating structure includes: an X-ray transmissible portion formed of a metal substrate having an X-ray transmissibility, i.e., an ability of transmitting X-rays, and provided in a given first region of the metal substrate; and a pored portion included of a plurality of pores and formed in a given second region, except for the X-ray transmissible portion, wherein at least one of the X-ray transmissible portion and the pored portion is provided plurally and periodically.

The intermediate product for an X-ray metal grating structure can be manufactured as a higher-performance X-ray metal grating structure by removing the pored portion to form a recess.

This application is based on Japanese Patent Application No. 2015-24301 filed on Feb. 10, 2015, the contents of which are hereby incorporated by reference.

To express the present invention, the present invention has been appropriately and sufficiently described through the embodiment with reference to the drawings above. However, it should be recognized that those skilled in the art can easily modify and/or improve the embodiments described above. Therefore, it is construed that modifications and improvements made by those skilled in the art are included within the scope of the appended claims unless those modifications and improvements depart from the scope of the appended claims.

1. A method for manufacturing an X-ray metal grating structure, comprising:
a resist layer forming step of forming a resist layer on at least one of opposite principal surfaces of a metal substrate;
a patterning step of patterning the resist layer and removing the resulting pattered portion of the resist layer,
an anodic oxidation step of forming a plurality of pores in a portion of the metal substrate corresponding to the removed portion of the resist layer, by an anodic oxidation process; and
a recess forming step of removing the portion formed with the plurality of pores, to thereby form a recess.

2. The method as recited in claim 1, further comprising a metal implantation step of implanting, into the recess, a second metal having a second property different from a first property of a first metal forming the metal substrate in terms of X-rays.

3. The method as recited in claim 1, wherein the recess forming step includes removing the portion formed with the plurality of pores, by a wet etching process, to thereby form a recess.

4. The method as recited in claim 1, wherein each of the plurality of pores extends in a thickness direction of the metal substrate.

5. The method as recited in claim 1, wherein the recess is a through-hole penetrating through the metal substrate in a thickness direction of the metal substrate.

6. The method as recited in claim 1, wherein each of the plurality of pores is formed in such a manner as to satisfy the following relationship: Ph≦dW, where:
W denotes a width of the recess;
dW denotes an allowable error (±) of the recess; and
Ph denotes a distance between adjacent ones of the plurality of pores, proportional to an applied voltage during the anodic oxidation process.

7. The method as recited in claim 1, wherein the plurality of pores are formed such that, when an X-ray source configured to radiate X-rays and intended to be disposed in conformity to the X-ray metal grating structure manufactured by the method is disposed at a given position with respect to the X-ray metal grating structure, they extend so as to converge toward a focal point of the X-rays radiated from the X-ray source.

8. The method as recited in claim 1, which is designed to manufacture an X-ray metal grating structure for use in an X-ray Talbot interferometer or an X-ray Talbot-Lau interferometer.

9. An X-ray imaging device comprising:
an X-ray source for radiating X-rays;
a Talbot interferometer or Talbot-Lau interferometer configured to be irradiated with X-rays radiated from the X-ray source; and
an X-ray imaging element for imaging X-rays from the Talbot interferometer or Talbot-Lau interferometer,
wherein the Talbot interferometer or Talbot-Lau interferometer includes one or more X-ray metal grating structure manufactured by the method as recited in claim 1.
